(19) United States
(12) Patent Application Publication
(10) Pub. No.: US 2010/0300435 A1
(43) Pub. Date: Dec. 2, 2010

(54) Oxygen helmet

(76) Inventor: Devaraj Thiruppathi, Columbus, GA (US)

Correspondence Address: DEVARAJ THIRUPPATHI, 7219 STONE CREEK LANE, COLUMBUS, GA, 31909, US

(21) Appl. No.: 12/455,045

(22) Filed: May 28, 2009

(51) Int. Cl. A62B 18/04; B01D 53/34; A62B 7/10

(52) U.S. Cl. 128/201.25; 422/168

(57) ABSTRACT

A motorcycle helmet having an oxygen conversion unit, which converts polluted air to breathable oxygen and other harmless compounds, while riding through the polluted atmosphere.

### FIELD OF THE INVENTION

The present invention relates to helmets, more particularly to a motorcycle helmet having an oxygen producing unit whereby allowing the user to inhale oxygen instead of pollution while riding trough a polluted atmosphere, whereby converting the external polluted air to breathable oxygen and other harmless compounds.

### BACKGROUND OF THE INVENTION

Various types of helmets have be created and evolved over the years as a protective device for the head while riding. There are many helmets with safety features such as two-way communication, AM/FM radios, turn signals, rearview mirrors, fragrance unit and other safety devices. The invention disclosed in U.S. Pat. No. 4,833,726 to Shinoda et al. has two-way radio communication facilities to be used by workers in the construction industry. The invention disclosed in U.S. Pat. No. 5,353,008 to Eikenberry et al. has break lights including a duty cycled receiver circuit for receiving a radio frequency signal from a transmitter located on the motorcycle. The invention disclosed in U.S. Pat. No. 6,167,574 B1 to Hayashida et al. has a fragrance device so the rider can inhale fragranced odors.

Helmets should not only be designed to protect the head of an individual from a fall but also protect the individual from the environment, such as low ground level pollution. Pollution is produced by many items such as cars, off-road vehicles, diesel truck, buses and industrial process all of which contribute to the production of ground level smog or pollution the motorcycle rider has to contend with. Pollution is a slow killer, slowly degrading the health of the individual with increased exposure to pollution. Increased exposure to pollution can lead to lung diseases and other complication to the body. The oxygen helmet not only protects the individual from head injury but also protect the individual from long-term injuries to the body as a whole. Aesthetically the oxygen helmet look and wears like a regular motorcycle helmet. The oxygen helmet transforms the polluted air from the environment to oxygen and other harmless compounds when the polluted air travels through the chemically treated unit located in the face bar of the helmet. The chemically treated unit can also be heated to increase efficiency of converting ground level pollution to oxygen. The chemical used, such as PrimiAir catalyst, to catalyze low level ground pollutant to breathable oxygen while the rider travels through the polluted environment, is but one example.

Thus it is desirable to provide an oxygen helmet, which allows the motorcycle oxygen helmet wearer to obtain oxygen while riding by converting the low ground level pollution to oxygen and not breathing the polluted air generated by traffic and industrial processes.

### SUMMARY OF THE INVENTION

The present invention is a oxygen helmet for motorcycle riders which is designed to have an aesthetic look, like any other motorcycle helmet and provide oxygen to the rider while the rider is traveling through the polluted atmosphere whereby having the polluted air passing through a oxygen conversion unit to convert the polluted air into fresh breathable oxygen and other harmless compounds for the rider. The oxygen conversion unit encompasses an exterior face bar shell and interior face bar shell. Both the exterior and interior face bar shell has corresponding opening to allow for airflow through the oxygen conversion unit to the breathing area of the rider. Also located within the oxygen conversion unit is an airflow control cover, which allows the rider to control the amount of polluted air that can enter the oxygen conversion unit. The oxygen conversion unit includes a honeycombed metal unit, which is coated with a chemical catalyst, such as or similar to the PrimeAir Catalyst, by Engelhard Corporation, Isclin, N.J., USA, to convert polluted air to oxygen and other harmless compounds when the polluted air comes in contact with the coated honeycombed metal unit and passes through it to the face of the rider. The chemical catalyst converts low ground level pollutants such as ozone to be catalyzed to form oxygen, carbon monoxide to be catalyzed to form carbon dioxide and hydrocarbons to be catalyzed to form water and carbon dioxide. The chemicals used for the catalysis of low ground level pollution will have a composition comprising of a support such as a refractory metal oxide support on which is dispersed a precious metal component. The refractory metal oxide support can comprise a support component selected from the group consisting of ceria, alumina, titania, zirconia, silica and mixtures thereof. The precious metal components are selected from platinum group components including palladium and/or platinum. It has been found that a combination of titania support with a platinum component results in the most effective catalyst for treating ozone, carbon monoxide, and hydrocarbons. Other useful compositions which can convert ozone to oxygen, carbon monoxide to carbon dioxide, hydrocarbons to carbon dioxide include a platinum component supported on carbon, a support comprising manganese dioxide, or a support comprising a coprecipitate of manganese oxide and zirconia. A metal honeycombed or metal mesh or a combination of both can be coated with the chemical catalyst with the object being to increase the surface contact of the chemical catalyst to the polluted air for increased efficiency of the catalyst. The honeycombed metal unit coated with the chemical catalyst works best under high temperatures in the range of 5 C to 105 C, therefore a power source is connected to the honeycombed metal unit to heat it up allowing to convert more types of polluted air to oxygen and other harmless compounds for the rider. The power source is a small battery, which can be recharged and be turned on and off by an on/off switch. The battery is recharged by a solar panel located on the oxygen conversion unit. The heated honeycombed unit will also evaporate any moisture caused by exhalation from rider and extend the life and efficiency of the coated catalyst on the honeycombed unit. Once the polluted air passes through the heated honeycombed unit it is turned into oxygen and other harmless compounds. To clean the air from debris a filter is placed behind the honeycombed metal unit, which traps any small particles and some polluted air and also absorbs any moisture from the breath of the wearer. The debris filter cleans the air by trapping particles in the air, as well as, cooling the air by evaporating the moisture absorbed from the breath of wearer. The debris filter can be removed and replaced when it get full of trapped particles. The oxygen conversion unit is held in an oxygen conversion holder and is detachable from the oxygen helmet and can be recharged separately and used separately. There are strap attachment sites on the oxygen conversion unit, which allows the straps to be attached to the oxygen conversion unit whereby allowing the rider to use the oxygen conversion unit without using the helmet. Therefore, in accordance with the present invention the oxygen helmet for motorcycle riders, having a aesthetic appearance, provides oxygen to the rider while riding through a polluted atmosphere by having polluted air passing through the opening in the oxygen conversion unit of the helmet, where polluted air is converted into oxygen and other harmless compounds for the rider through a chemical catalytic reaction.

These and other objects, features and advantages of the present invention will become apparent from the following detailed description. It should be understood, however, that the detailed description and the specific examples, while indicating preferred embodiments of the invention, are given by way of illustrations only, since various changes and modifications within the spirit and scope of the invention will become apparent to those skilled in the art.

### BRIEF DESCRIPTION OF THE DRAWINGS

The present invention will become more fully understood from the detailed description given herein below and the accompanying drawings, which are given by way of illustration only and are not limitative of the present invention, wherein:

FIG. 1 is a plan view of the side of oxygen helmet with the oxygen conversion unit inserted;

FIG. 2 is a plan view of the front side of oxygen helmet with the oxygen conversion unit inserted;

FIG. 3 is an illustrative view of the front side of oxygen helmet with the air control cover exposed;

FIG. 4 is a plan view of the backside of oxygen helmet with the oxygen conversion unit inserted;

FIG. 5 is a diagrammatic plan view of the side of oxygen helmet with the oxygen conversion unit being removed;

FIG. 6 is a plan view of the backside of oxygen helmet with the oxygen conversion unit removed;

FIG. 7 is a plan view of the side of the oxygen conversion unit;

FIG. 8 is an exploded view of the oxygen conversion unit;

FIG. 9 is a illustrative view of oxygen conversion unit with straps;

FIG. 10 is a plan front view of an oxygen helmet with side intake on oxygen side conversion units;

FIG. 11 is a diagrammatic view of oxygen helmet with side intake on oxygen side conversion unit being removed;

FIG. 12 is a plan side view of oxygen side conversion unit;

FIG. 13 is an exploded view of oxygen side conversion unit.

### DETAILED DESCRIPTION OF THE PREFERRED EMBODIMENT

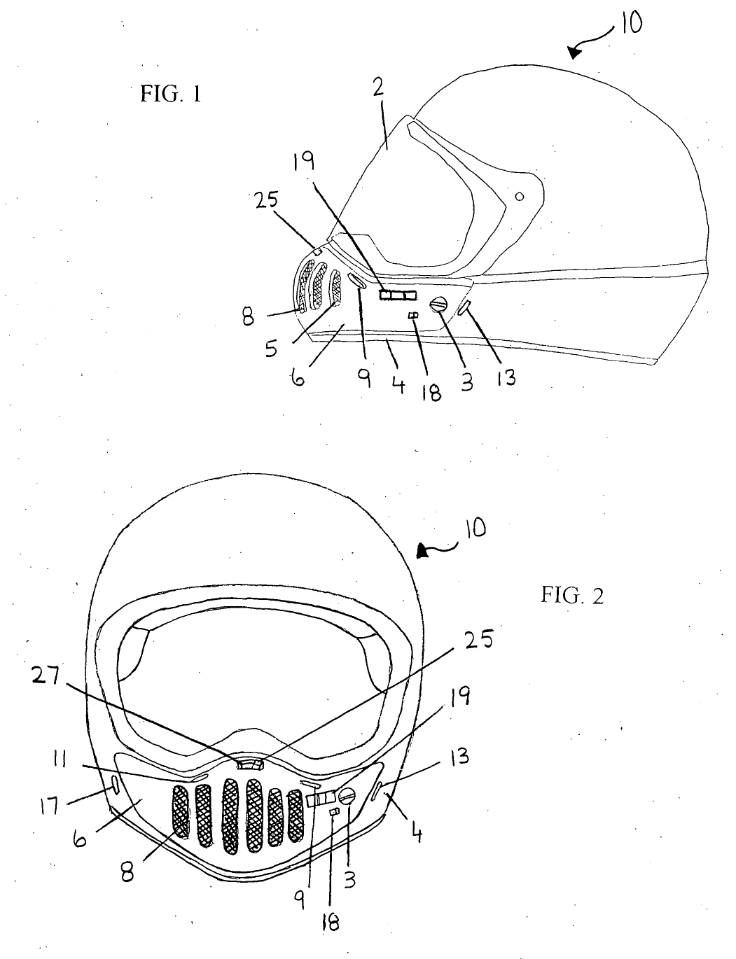

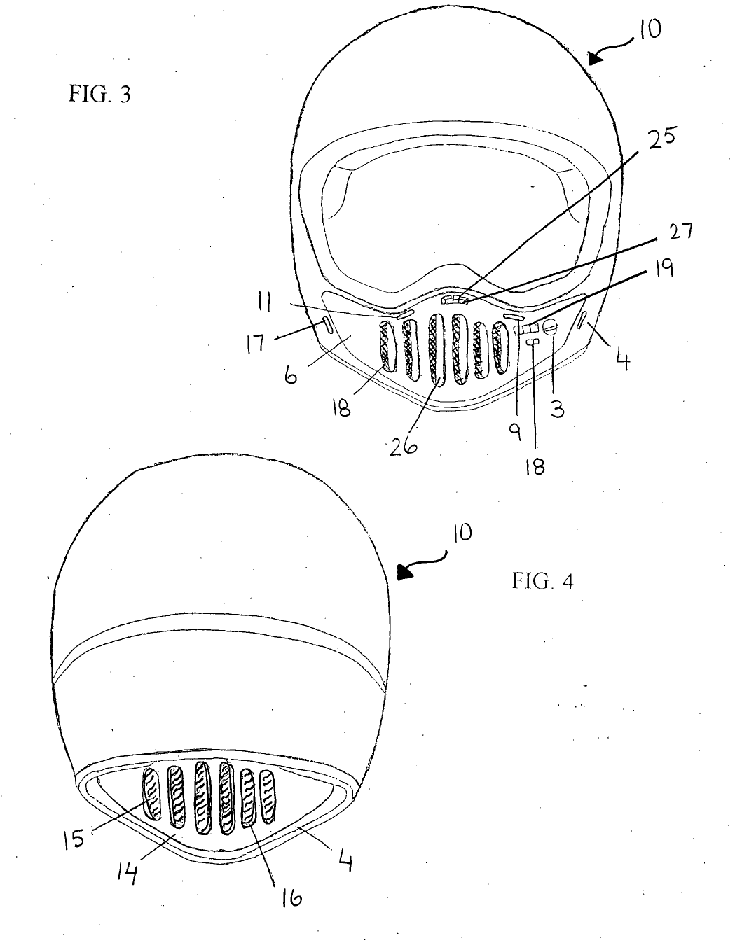

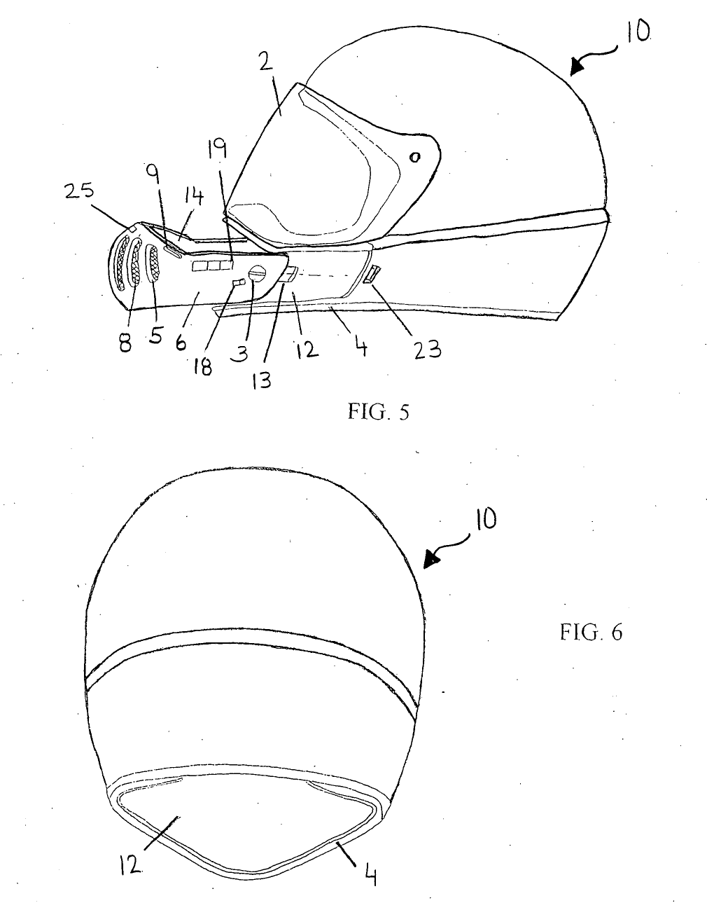

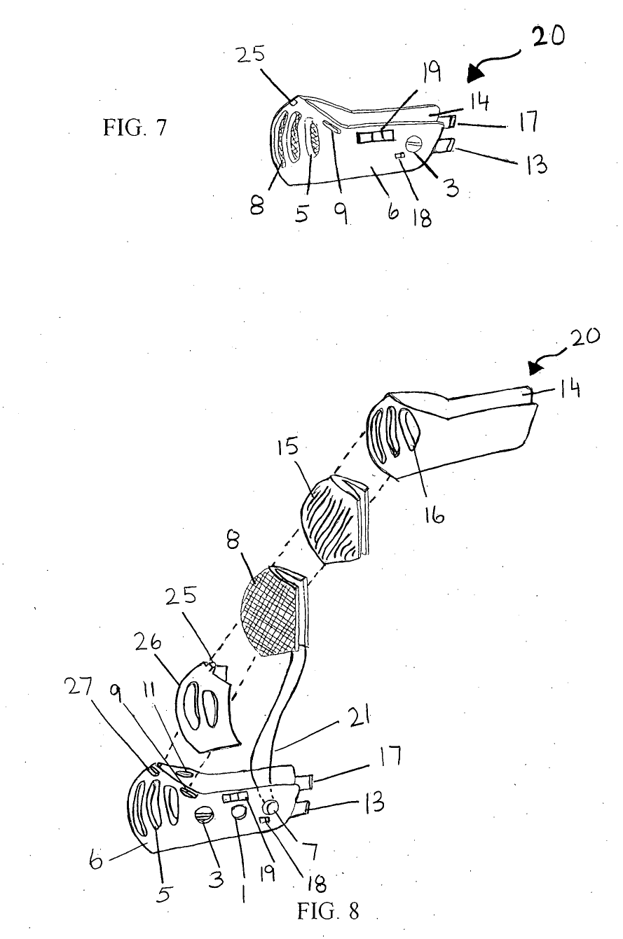

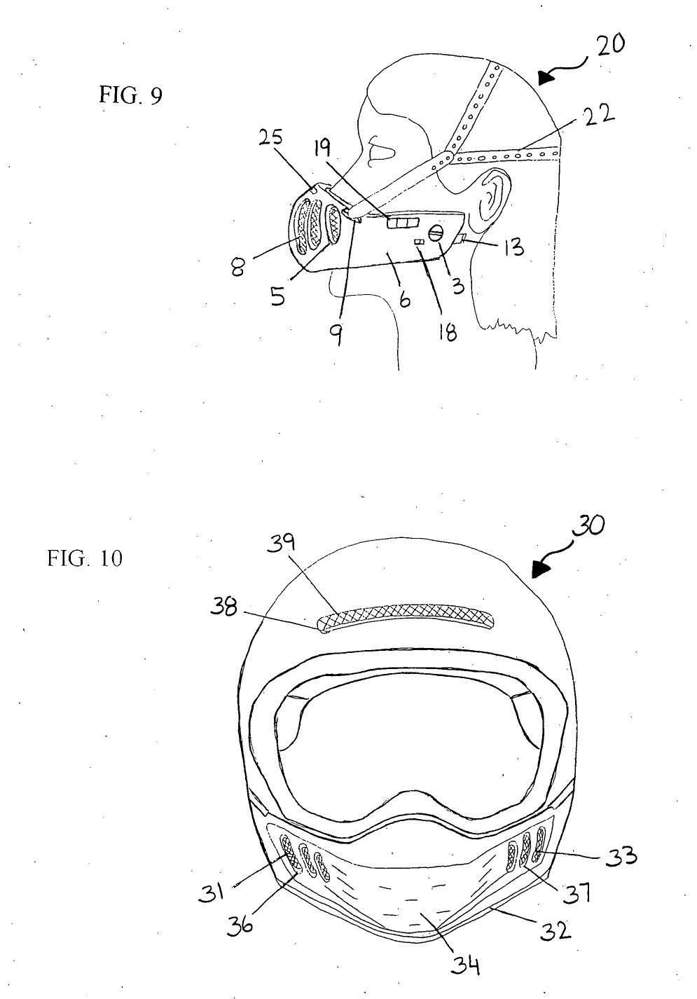

Referring now to the drawings wherein the depictions are for purposes of illustrating a preferred embodiment of the present invention only and not for the purpose of limiting the same. FIG. 1 is a plan view of an oxygen helmet 10 of the present invention. Oxygen helmet 10 is generally composed of a visor 2 to cover and protect the face from debris and to keep air out of face of rider, an oxygen conversion holder 4 that is a part of the helmet that contains an oxygen conversion unit 20 in FIG. 7. FIG. 1 depicts an exterior face bar shell 6, which is the outer shell of the oxygen conversion unit 20 and an exterior face bar opening 5 is the opening for air flow, a right strap attachment opening 9 and a battery cap 3. FIG. 1 also depicts a honeycombed metal unit 8 located behind the exterior face bar opening 5, which is responsible for catalyzing the polluted air to oxygen and other harmless compounds. The honeycombed metal unit 8 is coated with a chemical catalyst, such as PrimAir Catalyst, which converts low ground level pollution such as ozone to oxygen, carbon monoxide to carbon dioxide and hydrocarbons to water and carbon dioxide. FIG. 2 is a plan view of the front of the oxygen helmet 10 depicting the exterior face bar shell 6, the honeycombed metal unit 8 and the oxygen conversion holder 4. FIG. 2 also depicts the right strap attachment opening 9 and a left strap attachment opening 11. FIG. 2 also depicts a right unit attachment 13 and a left unit attachment 17, which attaches the oxygen conversion unit 20 to the helmet. An air control knob 25 and an air control opening 27 are depicted in FIG. 2 to control the amount air entering the oxygen conversion unit 20. FIG. 3 is an illustrative view on the air control knob 25 being moved to the center of the air control opening 27 whereby depicting the closure of the exterior face bar opening 5 by an air control cover 26. FIG. 4 is a plan view of the backside of the oxygen helmet 10 with the oxygen conversion unit 20 inserted into the oxygen conversion holder 4. FIG. 4 depicts an interior face bar shell 14 making up the interior shell of the oxygen conversion unit 20 and a corresponding opening to the exterior face bar opening 5 is an interior face bar opening 16, a debris filter 15 to catch particles before it reaches the face of rider and also absorbs the moisture of wearer's breath. FIG. 5 is a diagrammatic view of the oxygen helmet depicting the oxygen conversion unit 20 being removed from the oxygen helmet 10. FIG. 5 exposes a right attachment opening 23 where the right unit attachment 13 fits into. FIG. 5 depicts the oxygen conversion holder 4, the exterior face bar shell 6, the interior face bar shell 14, the exterior face bar opening 5, the honeycombed metal unit 8 and a face bar opening 12. FIG. 6 is a plan view of the backside of oxygen helmet 10 without the oxygen conversion unit 20. FIG. 6 depicts the oxygen conversion holder 4 and the face bar opening 12 with the oxygen conversion unit 20 removed. FIG. 7 is a plan view of the oxygen conversion unit 20 composed of the exterior face bar shell 6, interior face bar shell 14, exterior face bar opening 5 and the honeycombed metal unit 8. FIG. 8 is an exploded view of the oxygen conversion unit. FIG. 8 is composed of the exterior face bar shell 6 where the exterior face bar opening 5 is located and this opening allows for air passage, which correspondently aligns to the interior face bar opening 16 and this opening located on the interior face bar shell 14 which, allows oxygen to reach the face of wearer. The air control cover 26 is located behind the exterior face bar opening 5 where the air control knob 25 is inserted into the air control opening 27 located on the exterior face bar shell 6 to control the amount of air entering the oxygen conversion unit 20. In-between the exterior face bar shell 6 and the interior face bar shell 14 is the honeycombed metal unit 8, which is coated with a chemical catalyst, such as the PrimeAir Catalyst, that converts polluted air to oxygen and other harmless compounds and the debris filter 15, to catch particles and absorb moisture from the breath of wearer. FIG. 8 also depicts the power source which heats the honeycombed metal unit 8, which is a rechargeable battery 1 located in a battery holder 7. The rechargeable battery 1 is recharged by a solar panel 19 and can be switched on and off by an on/off switch 18. The battery holder 7 has an electrically conductive wires 21 extending from it and attaching to the honeycombed metal unit 8 to heat it up for a more efficient conversion of the polluted air to oxygen and other harmless compounds, when the polluted air travels through the chemically treated honeycombed metal unit 8. FIG. 9 is an illustrative view of the oxygen conversion unit 20 with a head strap 22 going around head of wearer. The head strap 22 is attached to the strap attachment opening 9 and the strap attachment opening 11 on exterior face bar shell 6 depicted in FIG. 8.

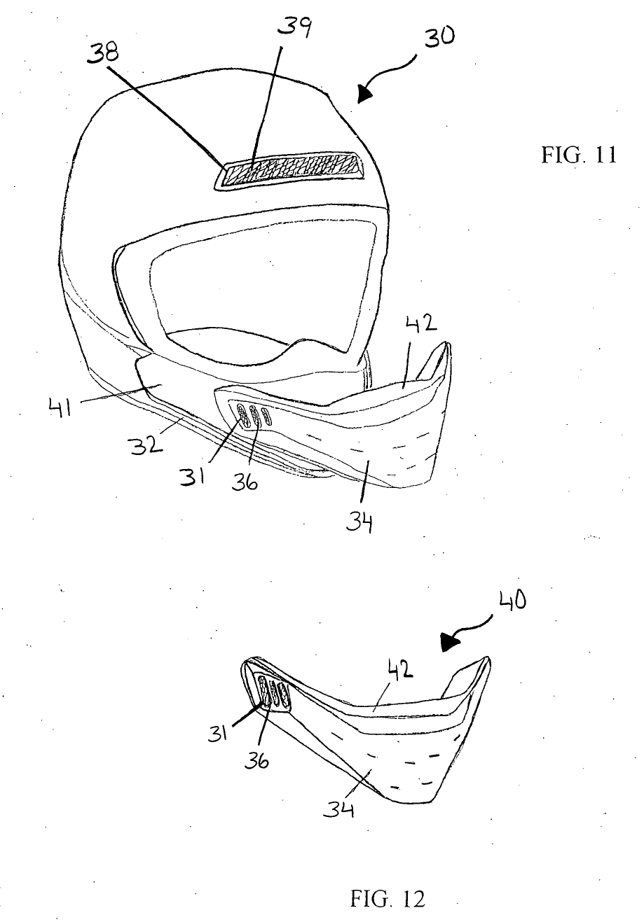

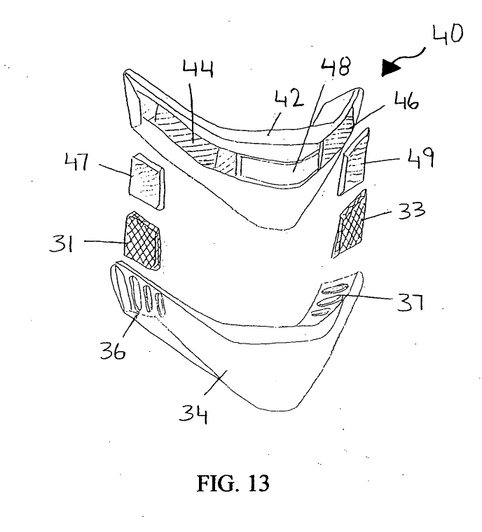

FIG. 10 is another embodiment of an oxygen helmet with side intake 30 with an oxygen side conversion unit 40 inserted. The oxygen helmet with side intake 30 is composed of an exterior double face bar shell 34, a left double face bar opening 36, and a right double face bar opening 37 to allow for air passage. A left honeycombed metal unit 31 and a right honeycombed metal unit 33 is located behind the exterior double face bar shell 34. There is an oxygen side conversion holder 32, which holds the oxygen side conversion unit 40. A helmet opening 38 is located on the head of the helmet and contains a head honeycombed metal unit 39, which is also coated with the chemical catalyst converting polluted air to oxygen and other harmless compounds and allows air to travel all though the interior of the helmet. FIG. 11 is a diagrammatic view of the oxygen helmet with side intake 30 with the oxygen side conversion unit 40 being removed. A double face bar opening 41 is exposed when the oxygen side conversion unit 40 is being removed. FIG. 11 depicts the oxygen side conversion holder 32 and also an interior double face bar shell 42 and the exterior double face bar shell 34, which hold the left honeycombed metal unit 31 and the right honeycombed metal unit 33. FIG. 12 is a plan view of the oxygen side conversion unit 40 without the helmet. The oxygen side conversion unit 40 is composed of the exterior double face bar shell 34, the interior double face bar shell 42, the left double face bar opening 36 and left honeycombed metal unit 31. FIG. 13 is an exploded view of the oxygen side conversion unit 40. FIG. 13 depicts the exterior double face bar shell 34 and interior double face bar shell 42 and left double face bar opening 36 and right double face bar opening 37. Behind the left double face bar opening 36 is the left honeycombed metal unit 31 and behind it is a debris filter 47 and then a left air duct 44, which guides the oxygen to the face of rider though a face opening 48. Behind the right double face bar opening 37 is the right honeycombed metal unit 33 and behind it is a debris filter 49 and then a right air duct 46, which guides the oxygen to the face of rider through the face opening 48.

What is claimed is:

1) A helmet comprising:
a) a visor;
b) an oxygen conversion unit;
c) an oxygen catalyzing means for converting low ground level pollution to oxygen and other harmless compounds located within said oxygen conversion unit.

2) The helmet of claim 1, wherein said oxygen catalyzing means is by a chemical catalyst, whereby polluted air coming in contact with said chemical catalyst is converted into oxygen.

3) The helmet of claim 2, wherein said chemical catalyst is coated onto a honeycombed metal unit.

4) The helmet of claim 3, wherein said oxygen conversion unit contains an air control cover and a debris filter.

5) The helmet of claim 4, wherein said oxygen conversion unit has an exterior face bar shell with an exterior face bar opening and an interior face bar shell with an interior face bar opening, whereby polluted air passes through said exterior face bar opening and gets catalyzed and out through said interior face bar opening to the rider.

6) The helmet of claim 5, wherein said oxygen conversion unit has a power source by heating means to heat said honeycombed metal unit.

7) The helmet of claim 6, wherein said power source is a battery having rechargeable means to replenish charge to said battery.

8) The helmet of claim 7, wherein said rechargeable means is by a solar panel.

9) The helmet of claim 8, having plurality of said oxygen conversion unit.

10) The helmet of claim 9, wherein said oxygen conversion unit by removable means can be removed from the helmet and held on head of wearer by a head strap and other end of said head strap is attached to a strap attachment opening.

11) A oxygen helmet consists of a visor and an oxygen conversion unit wherein said oxygen conversion unit consists of an exterior face bar shell and an interior face shell and between these shells is a honeycombed metal unit with a chemical catalyst coated onto said honeycombed metal unit, whereby the external polluted air passing through an exterior face bar opening located on said exterior face bar shell and then through said honeycombed unit, whereby being converted through a catalytic means of a chemical reaction to oxygen and other harmless compounds and passing out to the inside of said oxygen helmet through an interior face bar opening, located on said interior face bar shell.

12) The oxygen helmet of claim 11, has an air control cover behind said exterior face bar shell, whereby regulating air flow through the helmet.

13) The oxygen helmet of claim 12, has a debris filter located behind said honeycombed metal unit.

14) The oxygen helmet of claim 13, has plurality of said oxygen conversion unit.

15) The oxygen helmet of claim 14, wherein said honeycombed metal unit is heated by a power source connected by an electrically conductive wire.

16) The oxygen helmet of claim 15, wherein said power source is a battery having rechargeable means through a solar panel.

17) The oxygen helmet of claim 16, wherein said oxygen conversion unit by removable means can be removed from helmet.

18) The oxygen helmet of claim 17, has a head strap which can be attached to a strap attachment opening located on said oxygen conversion unit.

19) An oxygen conversion unit, wherein said oxygen conversion unit consists of an exterior face bar shell containing an exterior face bar opening and an interior face bar shell containing an interior face bar opening and between these shells is a honeycombed metal unit with a chemical catalyst coated on said honeycombed metal unit and a debris filter, which captures debris and moisture, located between said honeycombed metal unit and said interior face bar shell, whereby the external polluted air passing through an exterior face bar opening located on said exterior face bar shell and passing through said honeycombed metal unit coated with said chemical catalyst being converted to oxygen and other harmless compounds by a chemical reaction means and passing through said filter and passing through said interior face bar opening located on said interior face bar shell to the breathing area of wearer.

20) The oxygen conversion unit of claim 16, wherein said oxygen conversion unit by removable means be removed from helmet.
